(19) United States
(12) Patent Application Publication
(10) Pub. No.: US 2011/0142212 A1
(43) Pub. Date: Jun. 16, 2011

(54) METHOD AND APPARATUS FOR PROVIDING SERVICE ORIENTED COMMON ACCESS NETWORK SERVICE

(75) Inventors: Tae Yeon KIM, Daejeon (KR); Dong Guk JE, Daejeon (KR); Ho Young SONG, Daejeon (KR)

(73) Assignee: Electronics and Telecommunications Research Institute, Daejeon (KR)

(21) Appl. No.: 12/891,832

(22) Filed: Sep. 28, 2010

(30) Foreign Application Priority Data
Dec. 10, 2009 (KR) 10-2009-0122275

(51) Int. Cl. H04M 11/00

(52) U.S. Cl. 379/93.02

(57) ABSTRACT

Provided is an access node including: a receiver to receive subscriber information associated with a subscriber from a residential gateway of the subscriber and a service request from the subscriber; a storage unit to store registration information comprising the subscriber information and service information received from a plurality of service providers; and a processor to provide, to the residential gateway, a service corresponding to the service request based on the subscriber information.

### CROSS-REFERENCE TO RELATED APPLICATION

This application claims the benefit of Korean Patent Application No. 10-2009-0122275, filed on Dec. 10, 2009, in the Korean Intellectual Attribute Office, the disclosure of which is incorporated herein by reference.

### BACKGROUND

1. Field of the Invention

The present invention relates to a method of providing a network service, and more particularly, to an apparatus and method of providing a common access network service based on a service desired by a subscriber in a common access network environment where a variety of services are provided from a plurality of service providers.

2. Description of the Related Art

A service may be placed on one side of a value chain of a communication network, and a network and an equipment may be placed on another side of the value chain of the communication network. The communication network has been developed through close relationship therebetween. A broadcasting service may be connected to a cable network, a telephone service may be connected to a telephone device via a telephone line, and an Internet service may be connected to a plain old telephone service (POTS) and the like, and thereby be displayed on a PC.

However, a combined structure between the service and the network has currently been collapsed and instead, is being evolved into a form that the service is provided via another network, via another equipment, and the like. The above tendency is referred to as “unbundling of the value chain”.

In the unbundled value chain, a configuration of a desired package is enabled through combinations among contents, services, and networks. Various services may be provided via an access network and for this, players may be associated with each other.

Also, with development of communication technologies, there has been a desire for an infra environment for an intelligent residential network service. Accordingly, there is a need for an opne service platform where a service is shared. When the open service platform is completed at a point where various services and various service requests meet, it may be most effective.

### SUMMARY

An aspect of the present invention is to diversify a selection of a subscriber, to guarantee a freedom of service development for a service provider, and to offer low costs with respect to providing of a service via an access network where a plurality of providers shares various services.

Another aspect of the present invention is to construct a platform for providing of a service in an access network where services of various service providers and various service requests of service subscribers coexist, and to thereby enable a subscriber to easily use a desired service.

According to an aspect of the present invention, there is provided an access node, including: a receiver to receive subscriber information associated with a subscriber from a residential gateway of the subscriber and a service request from the subscriber; a storage unit to store registration information including the subscriber information and service information received from a plurality of service providers; and a processor to provide, to the residential gateway, a service corresponding to the service request based on the subscriber information.

According to another aspect of the present invention, there is provided a residential gateway, including: a controller to register, to an access node, a terminal of a subscriber and subscriber information associated with the subscriber, and to request the access node for a search according to a service request received from the terminal of the subscriber; and a transceiver to transmit the service request to the access node, and to receive, from the access node, information used to provide, to the terminal of the subscriber, a service corresponding to the service request.

According to still another aspect of the present invention, there is provided a common access network system, including: a residential gateway to receive a service request from a terminal of a subscriber; an access node to receive subscriber information from the residential gateway, and to provide, to the residential gateway, a service of a service provider selected from a plurality of service providers based on the subscriber information according to the service request; and a service providing apparatus to request the access node for registration of service information provided by the plurality of service providers, to receive, from the access node, at least one request of a connection to a service of the selected service provider, an authentication, and a network resource allocation, and to provide the service of the selected service provider to the terminal of the subscriber.

According to yet another aspect of the present invention, there is provided a method of controlling an access node, the method including: receiving subscriber information associated with a subscriber from a residential gateway of the subscriber and a service request from the subscriber; storing registration information including the subscriber information and service information received from a plurality of service providers; retrieving a service corresponding to the service request based on the subscriber information; and providing, to the residential gateway, a service corresponding to the service request.

### EFFECT

According to embodiments of the present invention, it is possible to quickly and accurately provide, to a resident network subscriber, various services provided by a plurality of service providers.

Also, according to embodiments of the present invention, it is possible to employ a common access node as a service platform of an access network.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a structure of a subscriber service performed by a conventional integrated service provider (ISP);

FIG. 2 is a diagram illustrating a configuration of a service oriented common access network according to an embodiment of the present invention;

FIG. 3 is a diagram illustrating a configuration of a residential gateway (RG), an access node, and a service providing apparatus in a service oriented common access network according to an embodiment of the present invention;

FIGS. 4A and 4B are diagrams illustrating a configuration between constituent elements in a service oriented common access network according to an embodiment of the present invention;

FIG. 5 is a diagram illustrating registration information according to an embodiment of the present invention;

FIG. 6 is a diagram illustrating a process of providing an integrated service according to an embodiment of the present invention;

FIG. 7 is a diagram illustrating a process of providing an active service according to an embodiment of the present invention;

FIG. 8 is a diagram illustrating a process of performing, by an access node, a subscriber authentication or an Internet Protocol (IP) allocation function according to an embodiment of the present invention; and

FIG. 9 is a diagram illustrating a process of doing, by an RG, a network connection management of a network gateway by proxy for providing an active service according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

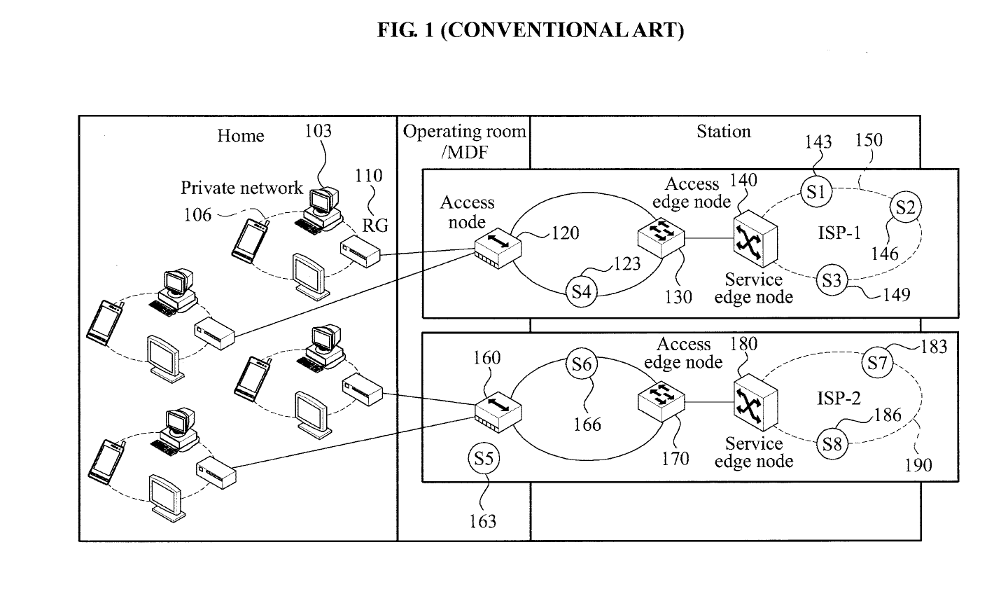

FIG. 1 is a diagram illustrating a structure of a subscriber service performed by a conventional integrated service provider (ISP).

Referring to FIG. 1, a terminal 103 included in a private network 106 desired for communication may be connected directly or via a distributor (not shown) to a residential gateway (RG) 110 of the private network 106 or an access node 120.

The access node 120 may be positioned in a common section of a main distribution frame (MDF) or an operating room located in a lead-in section of a subscriber via a modem connected to the terminal 103, a set-top box, and the like.

An access network may be connected, via a direct network from the access node 120, to an access edge node 130 generally called a Broadband Remote Access Server (BRAS). Consequently, a service may be provided via a service edge node 140. In this instance, most nodes excluding an actual access node may be positioned in a station independent for each service provider.

A service subscriber may pass through the access node 120 of a predetermined service provider, and receive an allocation or an authentication of an Internet Protocol (IP) address by the predetermined service provider in the access edge node 130, and then receive a corresponding service via the service edge node 140.

Referring to FIG. 1, an access node may perform only a simple function of providing a connection between a terminal connection apparatus of a subscriber end and an access edge node. Here, the access edge node may be an end terminal of an access network of a service provider. In this instance, an RG or a modem may be used as the terminal connection apparatus.

In an existing subscription service, when a subscriber joins a particular service provider, the subscriber may have no choice but to using a service within the range of services provided by the particular service provider.

For example, in FIG. 1, the RG 110 receiving a service from an ISP-1 150 may easily use various services (S1, S2, S3) 143, 146, and 149 that are provided by the ISP-1 150. However, the RG 110 may not use services (S7, S8) 183 and 186 provided by another service provider, that is, an ISP-2 190.

When various service providers are uniformly spread in a lead-in network, a concentration network, or a regional network, a service provider may need to receive a resource allocation and an authentication with respect to the access edge node 130 and the service edge node 140 so that the subscriber may receive a service from various service providers.

This may act as another limitation at this point that definition and scope of a service provider is being expanded, which may result in causing a waste of network resources.

When the subscriber desires to receive a service (S4) 123 in the access network via the RG 110, the subscriber may be connected to the service (S4) 123 after passing through the access edge node 130 and the service edge node 140 of the ISP-1 150 to which the RG 110 belongs. Even though a service provider providing the service (S4) 123 is positioned in the same region, the service provider may be connected via the service edge node 140 of the ISP-1 150.

In a home network, a service connected to an outside may be classified into communication equipments such as a PC or a telephone, information electronics such as a digital refrigerator, entertainment equipments such as audio-video (AV) or a game player, management equipments for inspection, security, and energy management, and the like.

The above home network equipments may use a service, or may receive a repair/maintenance and management online or offline via a separate contract with each of different service providers. Among the home network equipments, an apparatus needing a connection to an outside may be connected via an optical fiber, a hybrid fiber coax (HFC), a digital subscriber loop (DSL)/coax, a power line, and the like, and thereby receive a corresponding service.

Among the home network equipments, communication equipments such as a telephone, a TV, a PC, and the like need a connection to an external network at all times as a network exclusive equipment.

Other equipments may temporarily access the Internet, an external server, and the like to transmit and receive a required application or information.

As described above, in the case of apparatuses needing the connection to the external network at all times, the apparatuses may need the connection to the external network at all times in operation. However, in the case of apparatuses needing a temporary connection to the outside, there is no need that all the apparatuses may need to include a connection function to the outside.

Accordingly, an RG may need a function of obtaining required information from an external network and providing the obtained information to a corresponding equipment, instead of equipments needing the temporary connection. That is, the RG may need a gateway function for a network service.

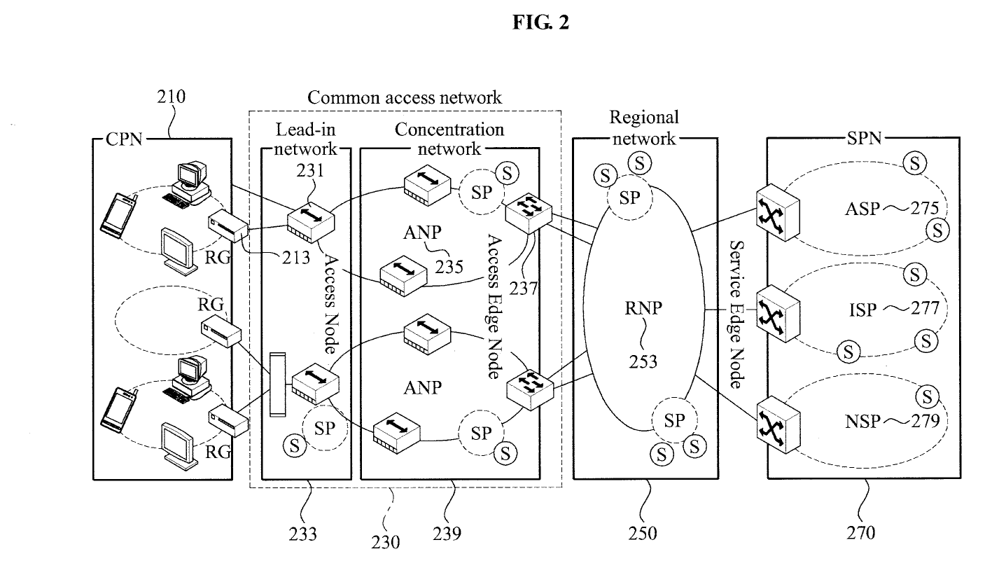

FIG. 2 is a diagram illustrating a configuration of a service oriented common access network according to an embodiment of the present invention.

Referring to FIG. 2, an equipment having an access function with respect to an external network may use a network address informed by an RG 213 to thereby access the corresponding address, and to receive a desired service.

However, an equipment not having the accessing function with respect to the external network may perform the corresponding function at the RG 213. The RG 213 may transfer the received service to the corresponding equipment via a customer premise network (CPN) 210.

A common access network 230 including a lead-in network 233 and a concentration network 239 may be owned and be operated by an independent access network provider (ANP) 235, which is different from the known art.

Accordingly, it is possible to perform an access network function for a common service provider, instead of performing a subordinate function by a particular service provider.

The common access network 230 may include at least one access node for a connection with the RG 213. Through this, the common access network 230 may transmit and receive a service and connection control request and response with respect to a subscriber of the CPN 210.

In the common access network 230, a network side that is an opposite side of a subscriber side may be expanded to an access edge node 237 called a BRAS, which may be selectively performed.

Specifically, the common access network 230 operated by the ANP 235 may necessarily need the access node 231 for a subscriber access. However, services such as a service authentication, a quality of service (QoS), an Internet Protocol (IP) allocation, and the like may be provided via a network constructed by an existing ISP 277.

As another characteristic of the common access network 230, a separate service provider excluding the existing ISP 277 may be directly connected to the lead-in network 233 or the concentration network 239, or a regional network 250 connecting the concentration network 239 and a service provider network (SPN) 270.

In the above SPN 270, the service provider may be a network service provider (NSP) 279 providing a network service, or a content provider (CP) providing only contents.

Also, the service provider may be a service provider of an RG, an application service provider (ASP) 275 providing a particular application program. The service provider is open to be connected to the access node 231 or the access edge node 237 to thereby directly provide a service to a corresponding subscriber.

The regional network 250 may exist between the access network 230 and the SPN 270 as necessary. The regional network 250 may be independently owned and be operated by an independent regional network provider (RNP) 253, or conversely may be configured by the ISP 277.

The service oriented common access network may support an open structure that may receive an ISP network and may simultaneously access various network services and applications services via an independent network provider network, thereby providing a service.

When providing a connection to the ISP network via a fixed connection such as an existing access network, it is difficult to provide a desired service of a service subscriber at a desired point in time.

Also, in the case of an existing access network, even through a service is expanded through separation of a network, it may be impossible to be aware which service needs to be connected among shared services, and to determine how to provide a service through which connection to which service provider. Therefore, the service may not be readily used.

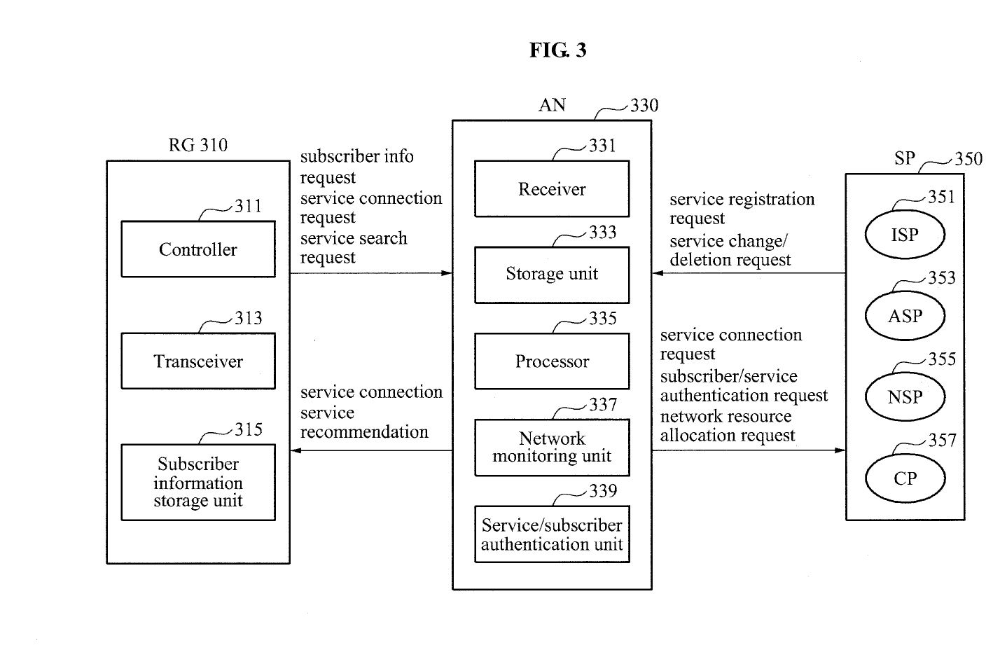

FIG. 3 is a diagram illustrating a configuration of a RG 310, an access node (AN) 330, and a service providing apparatus (SP) 350 in a service oriented common access network according to an embodiment of the present invention.

Referring to FIG. 3, the RG 310 may receive a service request from a terminal of a subscriber, and perform a function of a network gateway and a service gateway.

The RG 310 may include a controller 311, a transceiver 313, and a subscriber information storage unit 315. Also, although not illustrated in figures, the RG 310 may further include a network gateway, a service gateway, and a CPN manager.

The controller 311 may register, to the access node 330, the terminal of the subscriber and subscriber information associated with the subscriber, and may request the access node 330 for a search according to a service request received from the terminal of the subscriber.

The controller 311 may verify a service attribute based on subscriber information received from the terminal of the subscriber. A service providing scheme may vary depending on the service attribute required by the subscriber.

Specifically, when the verified service attribute is an active type, the controller 311 may provide connection information of a service provider capable of providing an optimal service retrieved according to a service request received from the terminal of the subscriber.

When the verified attribute of the service is an integrated type, the controller 311 may provide connection information of a pre-stored service provider to a customer premise equipment (CPE) or the terminal of the subscriber.

The transceiver 313 may transmit the service request to the access node 330, and may receive, from the access node 330, information used to provide, to the terminal of the subscriber, a service corresponding to the service request.

The subscriber information storage unit 315 may store a subscriber terminal connected to the same network as the RG 310, and subscriber information associated with the subscriber.

The subscriber information may include at least one of a type of a service requested by the terminal of the subscriber, a service class, a service attribute, and a QoS.

A network gateway (not shown) may notify network connection information predefined with respect to an external network connection required by the CPE, and may provide transmitted data to the access node 330 of the common access network.

When a request for a network service is received from the CPE, a service gateway (not shown) may obtain service information using the access node 330 and perform a relay function between the CPE and the access node 330 with respect to the service request.

The CPN manager may perform a network management of the CPE within the RG 310, and may also manage a service requested by the CPE, a network connected to provide the requested service, and the like.

All the services may be concentrated in the access node 330.

The access node 330 may receive subscriber information from the RG 310, and may provide, to the RG 310, a service of a service provider selected from a plurality of service providers based on the subscriber information according to the service request.

The access node 330 may include a receiver 331, a storage unit 333, and a processor 335. Also, the access node 330 may further include a network monitoring unit 337 and a service/subscriber authentication unit 339.

The receiver 331 may receive subscriber information associated with a subscriber from the RG 310 of the subscriber and a service request from the subscriber.

The above service request is received from the RG 310 of the subscriber by the access node 330 according to a service request from a CPN (not shown).

The subscriber information may include a service class, a service attribute, a QoS, and the like.

The service class denotes a class of a service requested by the subscriber, for example, the Internet, a TV, a video, and the like. The service attribute denotes a type of the serviced requested by the subscriber, that is, an integrated service or an active service. The service attribute will be further described below.

The QoS may include band information required to provide the service to the subscriber, quality information such as a QoS class, and the like.

Also, the subscriber information may include information associated with a contract relationship between a subscriber and a corresponding service provider, information associated with specification of a corresponding subscriber terminal, and information associated with a service satisfying the corresponding specification.

The storage unit 333 may store registration information including the subscriber information received from the receiver 331, and service information received from a plurality of service providers.

Here, subscriber information of the registration information stored in the access node 330 may be received from the RG 310, and the service information may be received from the service providing apparatus 350.

The registration information may include at least one of a name of the service provided to the subscriber, a provider of the service, a service class, a service attribute, a quality of service (QoS), an access scheme of a server for providing of the service, and an address of the server.

Here, the provider of the service may include information associated with various service providers capable of providing the service requested by the subscriber.

The access scheme of the server for providing of the service may include layer 2 (L2) or L3 including the address, information regarding whether an authentication server or a Dynamic Host Configuration Protocol (DHCP) server exists, an authentication, an IP allocation scheme, and the like. The processor 335 may provide, to the RG 310, a service corresponding to the service request.

Also, the processor 335 may retrieve and select the service corresponding to the service request from a plurality of service providers or service providing apparatuses based on the subscriber information received from the RG 310. Depending on embodiments, it is possible to select a service provider satisfying a requirement of the subscriber.

In this instance, the service of the selected service provider and connection information with respect to the selected service provider may be transmitted to the terminal of the subscriber connected to a CPN via the RG 310.

When retrieving the service corresponding to the service request of the subscriber, the processor 335 may retrieve the service based on the service attribute of the subscriber information received from the gateway 310.

According to an embodiment of the present invention, the access node 330 of the common access network may provide a service by the aforementioned conventional ISP, that is, an integrated service. Also, the access node 330 may provide a service, that is, an active service of retrieving a service, that is, a service provider satisfying a requirement of the subscriber, and providing the subscriber with an optimal service.

A service to be provided to the subscriber between the active service and the integrated service may be determined based on the service attribute of the subscriber information.

Accordingly, when the service attribute included in the subscriber information is the integrated service, the processor 335 may unconditionally connect the subscriber to a particular ISP, and enables a predetermined service provider to provide a service until a change is made for the service provider.

For this, the processor 335 may retrieve the predetermined service provider in the registration information, and may provide, to the RG 310, an address of a server of the predetermined service provider stored in a forwarding table. The forwarding table will be described below.

When the service attribute included in the subscriber information is the active service, the processor 335 may retrieve the service corresponding to the service request in the registration information, and may provide, to the RG 310, connection information used for the subscriber terminal to use the retrieved service.

Depending on embodiments, the processor 335 may retrieve the service corresponding to the service request for each service class, based on the registration information, and retrieve the service satisfying the requirement of the subscriber included in the subscriber information or the service request, and provide the connection information to the RG 310.

The processor 335 may register service information and perform a change and a deletion of the service information. Together with registration of the service information, the processor 335 may classify the registration information based on the service class, the service attribute, and the QoS, and store the classified registration information in the storage unit 333.

Together with storing of the service information, the processor 335 may construct an L2 or L3 forwarding table for a connection with the server for providing of the service corresponding to the service request, using an address of the server.

The network monitoring unit 337 may monitor a network connection state between constituent elements connected to the access node 330 in the common access network, a network quality, and the like.

The service/subscriber authentication unit 339 may perform an authentication with respect to a service requested by the subscriber and a right to use, required to use the requested service. In particular, the service/subscriber authentication unit 339 may be generally used when the CPE includes an external communication function, or when the access node 330 directly provides service connection information to the CPE or the terminal of the subscriber.

The service providing apparatus 350 may request the access node 330 for registration of service information provided by the plurality of service providers, receive, from the access node 330, at least one request of a connection to a service of the selected service provider, an authentication, and a network resource allocation, and provide the service of the selected service provider to the terminal of the subscriber.

The service providing apparatus 350 may request the access node 330 for a service management including a registration, a change, and a deletion of the service provided to the subscriber by the plurality of service providers, may receive, from the access node 330, the request such as the connection to the selected service, the authentication, the network resource allocation, and the like, and may provide the selected service.

For this, the service providing apparatus 350 may include at least one of an ISP 351, an ASP 353, an NSP 355, and a CP 357.

The ISP 351 may store service network connection information for providing of its service.

So that the ASP 353 or the CP 357 may provide a service of a provider, an application server of the ASP 353 or a content server of the CP 357 may need to be included in a corresponding access network.

Also, service information containing a specification of a service function, a service attribute, a QoS, and the like may be stored. Connection information for using the service may be required.

A service of the service provider providing an independent network connection service to an ANP, an RNP, and the like may be registered to the NSP 355. Also, a connection range of the network connection service, a guaranteed band, a traffic quality, and the like may be registered as service information.

The NSP 355 may also register a service of another service provider connected to the NSP 355 using the same scheme as a registration scheme of the ASP 353 and the CP 357.

The network connection service may include a network monitoring service to make it possible to obtain the quality of an available connection service in real time. The available connection service may vary in real time. In this instance, depending on embodiments, the network connection service may perform a function of performing a service and a subscriber authentication as proxy according to a contract and a request of the service provider.

When a subject receiving the service request through the service registration, management, and subscriber information is not the application node 330, a private network section and a service provider network section may be considered.

When a registration and a management of the service are performed in the private network section, descriptions of services provided from all the access nodes and service nodes may be distributed to homes of all the subscribers and thereby it is possible to directly provide a service in a private network.

However, in the above case, all the network information may need to be redundantly registered in all the private networks. Therefore, it is economically inefficient and gives burden to the performance of an RG apparatus. In addition, it is unsuitable for a separation criterion of data, that is, a separation criterion of a residential network and an external network.

When a registration, providing, and a management of a service are performed in the service network, a registration and a management with respect to a third provider connected to the service network or a service connected to the service network may be smoothly performed. However, in the above case, it may be difficult to manage information of a small-sized service provider or a service connected to the access network or a regional network.

Accordingly, an optimal location where a registration and a management of a service to be provided for a subscriber are performed may be an access node where it is relatively easy to receive a service request from the subscriber.

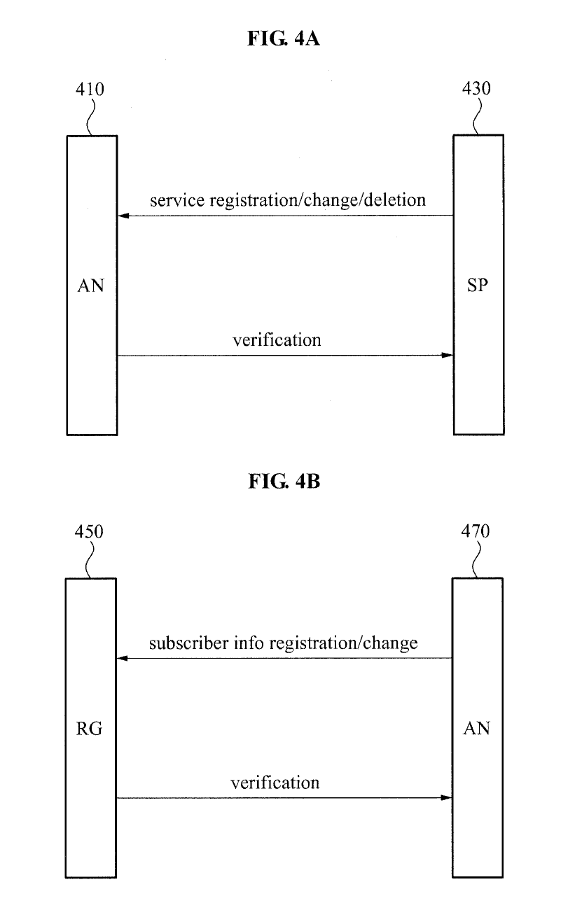

FIGS. 4A and 4B are diagrams illustrating a configuration between constituent elements in a service oriented common access network according to an embodiment of the present invention.

FIGS. 4A and 4B illustrate an example of a service provided between constituent elements in a state where functions of the constituent elements are separated in the common access network as shown in FIG. 3.

FIG. 4A shows a registration/change/deletion procedure of a service performed between an access node (AN) 410 and a service providing apparatus (SP) 430 in the service oriented common access network.

Referring to FIG. 4A, a service registered in the access node 410 may be provided in various types of forms, for example, an integrated service, a network service, a content service, an application service, and the like. Registration information registered in the access node 410 may be retrieved and be used based on a requested service attribute in subscriber information of a subscriber. The registration information registered in the access node 410 may be changed or be deleted.

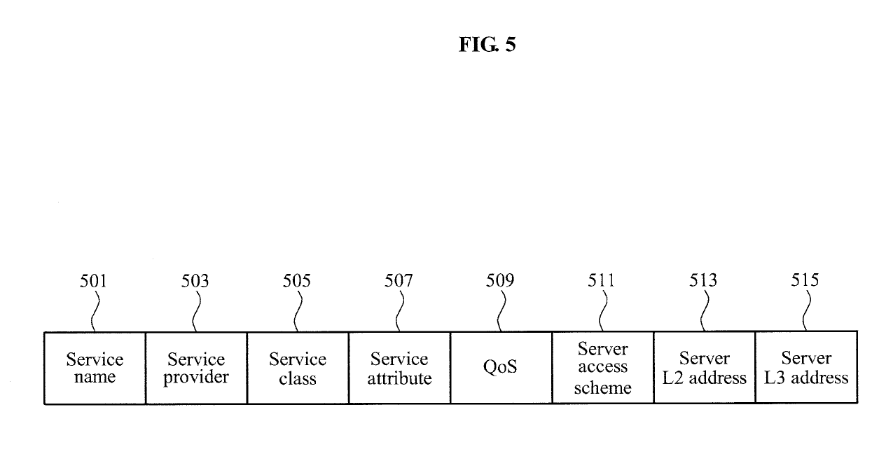

The registration information registered and stored in the access node 410 may be expressed as shown in FIG. 5.

FIG. 5 is a diagram illustrating registration information according to an embodiment of the present invention.

Referring to FIG. 5, in the case of a registration of a service, a service name 501 and a service provider 503 may be required. A service class 505 such as the Internet, a telephone, a video, a TV, and the like may also be required.

A service attribute 507 may include a service characteristic required for retrieving the service, and a QoS 509 may include information such as a QoS class and a band used for the service.

A server access scheme 511 indicates a scheme for accessing a server providing the service.

A server L2 address 513 and a server L3 address 515 correspond to an address of a server providing a corresponding service, and may be used when the access node 410 constructs a forwarding table for a connection with the server.

Together with the service registration, the access node 410 may store a service in a storage unit based on a service class, a service attribute, and a QoS, and construct an L2 or L3 forwarding table for a connection to the server using an address of the server, and verify the forwarding table.

FIG. 4B shows a registration and change procedure of subscriber information performed between an RG 450 of a subscriber private network and an access node (AN) 470 according to an embodiment of the present invention.

The RG 450 may register, to the access node 470 of a common access network, subscriber information of a subscriber or a terminal belonging to a CPN of the RG 450. Here, the subscriber information may include a service attribute.

The service attribute indicates whether a service type is an integrated service or an active service. When the service type is the integrated service, the subscriber may request an unconditional connection to a particular ISP, which is similar to a subscription service performed by the conventional ISP. Accordingly, the access node 470 may change a service provider according to a request of the subscriber. The service may be provided by a predetermined service provider until the change is made.

When the service type is the active service, the access node 470 may provide a dynamic connection service which retrieves a registered service capable of satisfying requirements of the subscriber through search for each service with respect to the service requested by the subscriber based on subscriber information or the subscriber request, and connects the subscriber to the service.

In the case of the integrated service, the access node 470 may retrieve the predetermined service provider and may inform the RG 450 about an address of a server stored in a corresponding forwarding table.

The RG 450 may receive, from the access node 470, connection information associated with a service provider corresponding to the service request of the subscriber, and store the connection information. As necessary, the RG 450 may inform the CPE about corresponding connection information (for example, an address of a server, and the like), enabling a data communication for an Internet service and the like between the CPE and the server.

When the service provider is changed, the RG 450 may update a server address of the changed service provider and transmit the updated address to the CPE.

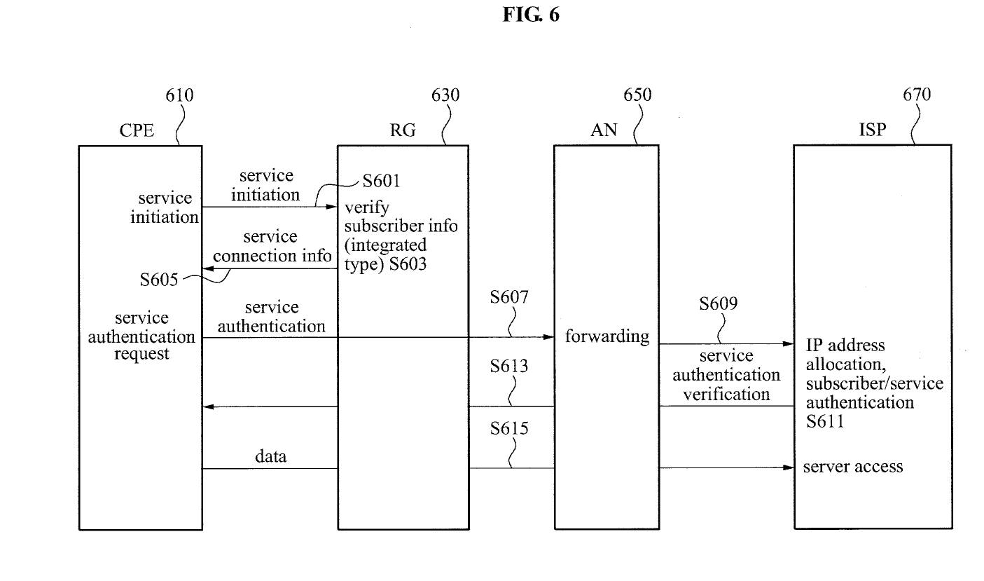

An example of the integrated service will be described with reference to FIG. 6.

FIG. 6 is a diagram illustrating a process of providing an integrated service according to an embodiment of the present invention.

Referring to FIG. 6, an RG 630 may receive a service initiation signal from a CPE 610 (S601), and verify subscriber information (S603). When the subscriber information is determined as an integrated type, the RG 630 may retrieve a predetermined ISP in registration information, and provide, to the CPE 610, an address of the retrieved ISP, for example, an address of an ISP 670 as service connection information (S605).

The CPE 610 receiving the address of the ISP 670 may request the address of the server for an authentication with respect to a service and a corresponding equipment (S607).

An access node (AN) 650 may select a service of a service provider stored in a pre-constructed forwarding table according to the authentication request of the CPE 610, and transmit, to the RG 630 of the subscriber, an address of the server pre-stored in the forwarding table, for example, an authentication server or a server of the service provider (S609).

For this, prior to operation S609, the access node 650 may construct the forwarding table for connection to the server, using the address of the server for providing of the service corresponding to the service request from the RG 630, and more accurately, from the CPE 610.

The ISP 670 may allocate an IP address to a terminal of the subscriber requesting the service and perform an authentication with respect to the service and the subscriber in a service network (S611).

The CPE 610 may receive the authentication from the ISP 670 (S613). The CPE 610 may transmit data to the ISP 670 and access the server of the ISP 670 to receive the requested service (S615). In this instance, when the address of the server stored in the forwarding table is changed, the access node 650 may update the address of the server for providing of the service.

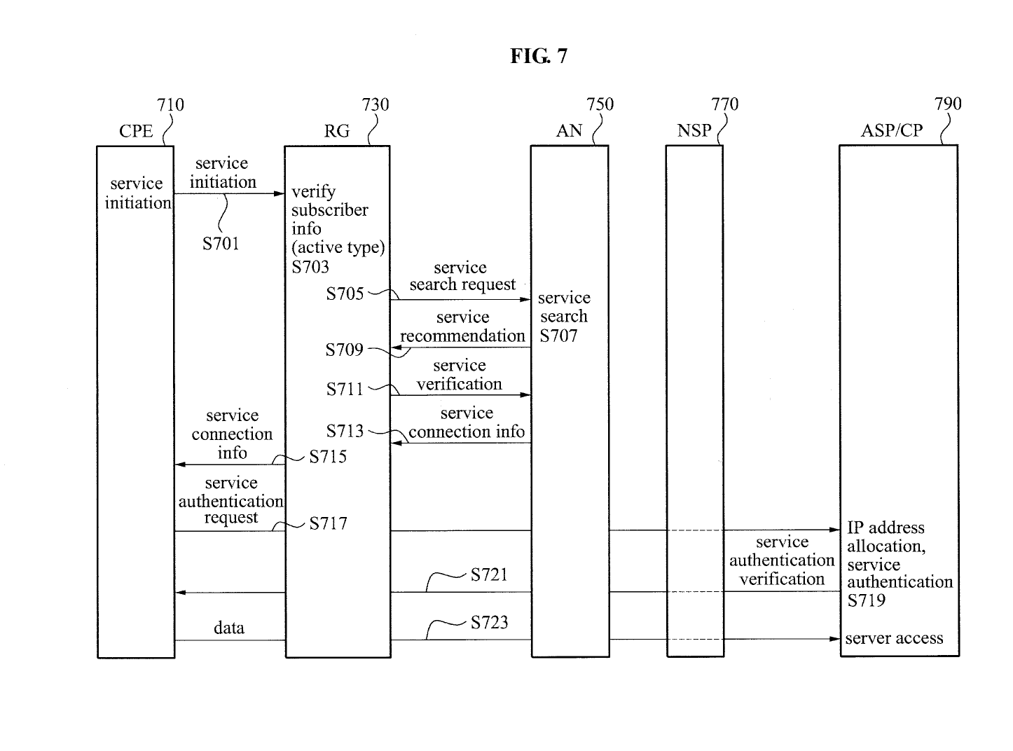

FIG. 7 is a diagram illustrating a process of providing an active service according to an embodiment of the present invention.

Referring to FIG. 7, an RG 730 may receive a service initiation signal from a CPE 710 (S701) and verify subscriber information (S703). When the subscriber information is determined as an active type, the RG 730 may request an access node (AN) 750 for search of a service requested by a subscriber (S705). The access node 750 may receive subscriber information from at least one RG and a service request from the subscriber.

The access node 750 may register and store registration information including the subscriber information received from the RG 730 and service information received from a plurality of service providers.

The subscriber information included in the registration information may include a service class, a service name, a service attribute, and the like, which is received by the RG 730 from the CPE 710.

The service quality may include at least one of a provider of a corresponding service, a QoS provided by the plurality of service providers, an access scheme of a server for providing of the service, and an address of the server.

The access node 750 may classify the registration information based on the service class, the service attribute, and the QoS, and thereby store the classified registration information.

The access node 750 may retrieve a service corresponding to a service request from a subscriber among the plurality of service providers based on the subscriber information (S707). Depending on embodiments, the access node 750 may retrieve a service of a service provider corresponding to a requirement of the subscriber information.

When at least one service satisfying the service requested by the subscriber or the requirement of the subscription information is retrieved, the access node 750 may select the retrieved at least one service as a recommended service, and transmit the at least one recommended service to the RG 730 (S709).

The RG 730 may select, from the at least one recommended service, a service determined to be most suitable for a characteristic of the CPE 710, and may transmit, to the access node 750, an acknowledgement signal indicating an intent to receive the selected service (S711).

The access node 750 may transmit, to the RG 730, connection information for receiving the selected service, that is, the service corresponding to the service request (S713).

The connection information may include an address of an authentication server, an address of a main server, and the like for receiving the service corresponding to the service request.

The RG 730 may verify whether the CPE 710 includes an external communication function. When the CPE 710 includes the external communication function, the RG 730 may transmit connection information of the service to the CPE 710 (S715).

The CPE 710 may request an an ASP or a CP (ASP/CP) 790 for authentication with respect to the service using connection information of the service (S717).

The ASP/CP 790 receiving the authentication request from the CPE 710 may allocate an IP address to a terminal of a subscriber desiring to receive the service, and perform the authentication with respect to the subscriber and the service (S719).

The CPE 710 may receive, from the ASP/CP 790, an authentication verification with respect to the service (S721). Accordingly, the CPE 710 may transmit service request data, for example, HTTP protocol data to the ASP/CP 790, and thereby receive the service together with the server access (S723).

In this instance, a package connection between service providers, for example, an ASP, a CP, an RNP, and the like may be possible.

For example, when a selected service provider (an ASP or a CP) is accessible via a particular NSP 770, a connection may be requested to the ASP 790 and the like via the NSP 770. Then, the NSP 770 may connect the common access network 750 and the ASP 790, and the ASP 790 may complete a service connection through a connection between the subscriber and the server.

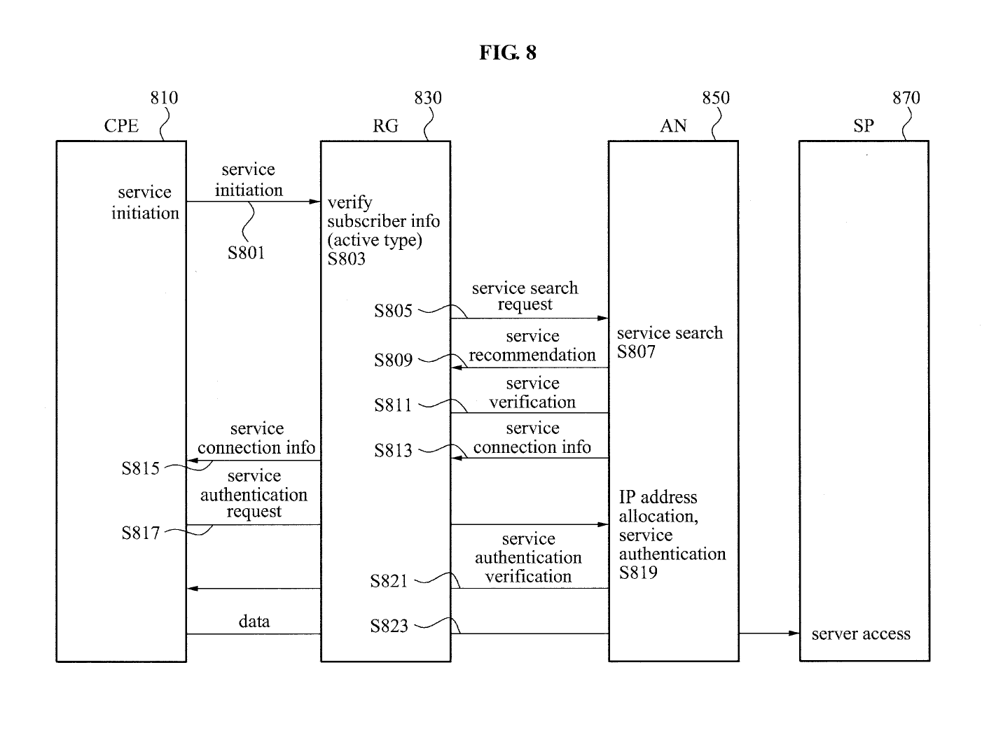

When the ASP/CP 790 providing the service may not perform a subscriber authentication or an IP allocation function, the access node 750 of the common access network may perform the above function. It will be described with reference to FIG. 8.

FIG. 8 is a diagram illustrating a process of performing, by an access node (AN) 850, a subscriber authentication or an IP allocation function according to an embodiment of the present invention.

Referring to FIG. 8, a process of S801 through S815 is the same as a process of S701 through S715 of FIG. 7 and thus further detailed description will be omitted here.

When a CPE 810 requests an authentication server, that is, an SP 870 for a service authentication, however, the authentication server may not perform a subscriber authentication or IP allocation function, the access node 850 may perform the above function (S817) and thereby perform an allocation of an IP address and an authentication between the subscriber and the service (S819).

Specifically, the access node 850 may receive, from a terminal of the subscriber, an authentication request for a selected service, may allocate, to the terminal of the subscriber, the IP address for receiving the selected service, and may perform the authentication with respect to the terminal of the subscriber and the selected service based on the allocated IP address.

The access node 850 may verify the authentication with respect to the service (S821), and receive data from the CPE 810 (S823) and thereby provide the service.

In this instance, an address of the access node 850 may be designated as an address of the authentication server. A server address of the SP 870 may be designated as an address of the main server.

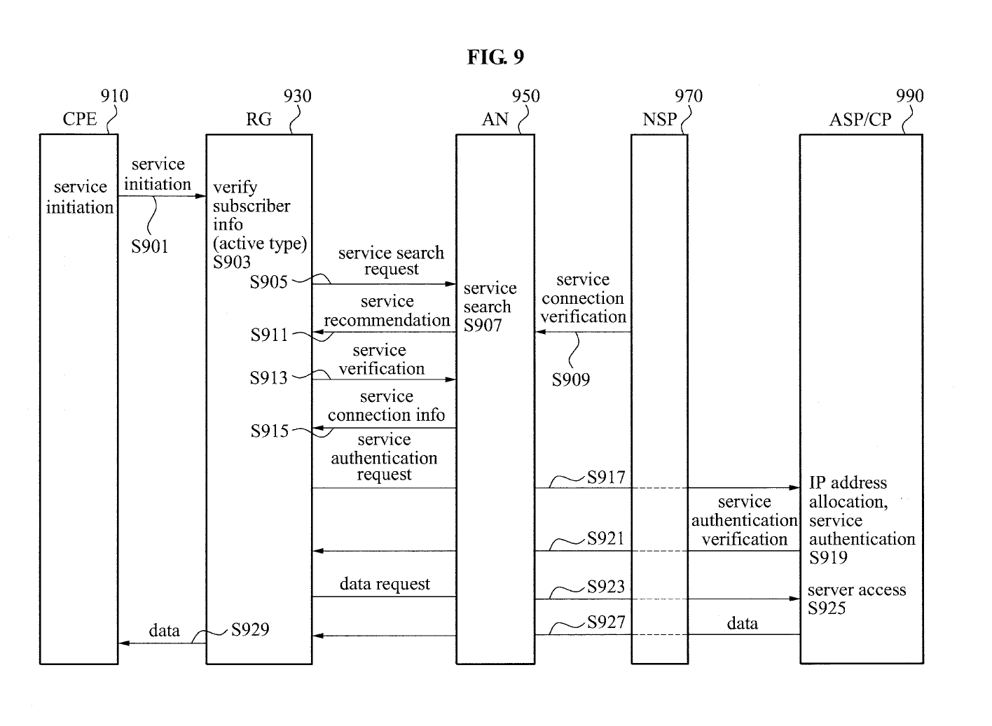

FIG. 9 is a diagram illustrating a process of doing, by an RG 930, a network connection management of a network gateway by proxy for providing an active service according to an embodiment of the present invention.

Referring to FIG. 9, when a CPE 910 does not include an external network function, the RG 930 may receive desired data through a service authentication and a data connection, and provide a service to the CPE 910 via a CPN.

The RG 930 receiving a service initiation request from the CPE 910 (S901) may verify subscriber information (S903).

When the subscriber information is determined as an active type, the RG 930 may request an access node (AN) 950 for retrieving a corresponding service (S905).

The access node 950 may retrieve the service requested by the subscriber using a service class, a service name, a service attribute, and the like received from the CPE 910 (S907).

When at least one service satisfying a requirement of the subscriber is retrieved, the access node 950 may transmit the at least one service to the RG 930 as a recommended service (S911).

Prior to S911, the access node 950 may verify a service connection from an NSP 970 (S909) to perform a network connection management of a network gateway.

The RG 930 may select, from the at least one recommended service, a service determined to be most suitable for a characteristic of the CPE 910, and may transmit, to the access node 950, an acknowledgement signal with respect to the selected service (S913).

The access node 950 may inform the RG 930 about connection information required to receive the selected service, that is, an address of an authentication server and a main server to receive the service (S915).

As assumed above, the CPE 910 does not include a connection function with respect to an external network. Instead of the CPE 910, the RG 930 may request the authentication server, for example, an ASP or a CP 990 for a service authentication (S917).

The ASP or the CP 990 may perform an allocation of an IP address and an authentication with respect to the service (S919), and may transmit, to the RG 930, an authentication acknowledge signal with respect to the service (S921).

The RG 930 may request the authentication server for service data of the subscriber (S923) and access the server (S925). In response thereto, the RG 930 may receive the service data (S927) and transmit the service data to the CPE 910 (S929).

In the aforementioned coon access network system, the constituent apparatuses such as an RG, an access node, a service providing apparatus, and the like, and method, descriptions related to constituent elements having the same name, terms, and other things may be referred to each other.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these to exemplary embodiments without departing from the principles and spirit of the invention, the scope of which is defined by the claims and their equivalents.

What is claimed is:

1. An access node, comprising:
a receiver to receive subscriber information associated with a subscriber from a residential gateway of the subscriber and a service request from the subscriber;
a storage unit to store registration information comprising the subscriber information and service information received from a plurality of service providers; and
a processor to provide, to the residential gateway, a service corresponding to the service request based on the subscriber information.

2. The access node of claim 1, wherein the processor registers the service information, and performs a change and a deletion of the service information.

3. The access node of claim 1, wherein the registration information comprises at least one of a name of the service provided to the subscriber, a provider of the service, a service class, a service attribute, a quality of service (QoS), an access scheme of a server for providing of the service, and an address of the server.

4. The access node of claim 1, wherein:
the registration information comprises at least one of a service class of the service provided to the subscriber, a service attribute, and a QoS, and
the processor classifies the registration information according to the service class, the service attribute, and the QoS, and stores the classified registration information in the storage unit.

5. The access node of claim 1, wherein:
the registration information comprises an address of a server for providing of the service corresponding to the service request, and
the processor configures a forwarding table for a connection to the server using the address of the server.

6. The access node of claim 1, wherein:
the subscriber information comprises a service attribute, and
the processor retrieves the service based on the service attribute.

7. The access node of claim 6, wherein when the service attribute is an active type, the processor retrieves the service corresponding to the service request in the registration information and provides, to the residential gateway, connection information for receiving the retrieved service.

8. The access node of claim 6, wherein:
the processor configures a forwarding table for a connection to a server for providing of the service corresponding to the service request, using an address of the server, and
when the service attribute is an integrated type, the processor retrieves a predetermined service provider in the registration information and provides the address of the server to the residential gateway.

9. A residential gateway, comprising:
a controller to register, to an access node, a terminal of a subscriber and subscriber information associated with the subscriber, and to request the access node for a search according to a service request received from the terminal of the subscriber; and
a transceiver to transmit the service request to the access node, and to receive, from the access node, information used to provide, to the terminal of the subscriber, a service corresponding to the service request.

10. The residential gateway of claim 9, further comprising:
a subscriber information storage unit to store the subscriber information,
wherein the subscriber information comprises at least one of a type of a service requested by the terminal of the subscriber, a service class, a service attribute, and a QoS.

11. The residential gateway of claim 9, wherein:
the subscriber information comprises a service attribute, and
when the service attribute is an active type, the controller provides, to the terminal of the subscriber, connection information of a service provider retrieved according to the service request.

12. The residential gateway of claim 9, wherein:
the subscriber information comprises a service attribute, and
when the service attribute is an integrated type, the controller provides connection information of a pre-stored service provider to the terminal of the subscriber.

13. A common access network system, comprising:
a residential gateway to receive a service request from a terminal of a subscriber;
an access node to receive subscriber information from the residential gateway, and to provide, to the terminal of the subscriber, a service of a service provider selected from a plurality of service providers based on the subscriber information according to the service request; and
a service providing apparatus to request the access node for registration of service information provided by the plurality of service providers, to receive, from the access node, at least one request of a connection to a service of the selected service provider, an authentication, and a network resource allocation, and to provide the service of the selected service provider to the residential gateway.

14. A method of controlling an access node, the method comprising:
receiving subscriber information associated with a subscriber from a residential gateway of the subscriber and a service request from the subscriber;
storing registration information comprising the subscriber information and service information received from a plurality of service providers;
retrieving a service corresponding to the service request based on the subscriber information; and
providing, to the residential gateway, a service corresponding to the service request.

15. The method of claim 14, further comprising:
receiving an authentication request for the service from a terminal of the subscriber;
allocating, to the terminal of the subscriber, an Internet Protocol (IP) address for receiving the service; and
performing an authentication with respect to the terminal of the subscriber and the service based on the allocated IP address.
